(19) United States
(12) Patent Application Publication
(10) Pub. No.: US 2022/0414955 A1
(43) Pub. Date: Dec. 29, 2022

(54) ANGLE ERROR ESTIMATING APPARATUS, METHOD AND PROGRAM

(71) Applicant: Rigaku Corporation, Tokyo (JP)

(72) Inventor: Takumi OTA, Tokyo (JP)

(73) Assignee: Rigaku Corporation, Tokyo (JP)

(21) Appl. No.: 17/846,207

(22) Filed: Jun. 22, 2022

(30) Foreign Application Priority Data
Jun. 28, 2021 (JP) 2021-106771

(51) Int. Cl. G06T 11/00; G01N 23/046; G01N 23/083

(52) U.S. Cl. CPC G06T 11/008; G01N 23/046; G01N 23/083; G06T 11/005; G01N 2223/04; G01N 2223/419

(57) ABSTRACT

The angle error estimating apparatus 310 comprises a storing section 315 for storing a series of projection data of an X-ray CT and control values of projection angles respectively associated with the projection data, a temporary correction section 330 for correcting the control values of the projection angles to temporary correction values with an error model using an assumed parameter, a temporary reconstruction section 332 for reconstructing a plurality of temporarily corrected images using the temporary correction values of the projection angles for each of different projection data sets composed of a part of the series of projection data, a consistency evaluating section 340 for evaluating consistency of the plurality of temporarily corrected images, and a parameter determining section 345 for determining an optimum parameter used for the error model based on the evaluated consistency.

### RELATED ART

### Field of the Invention

The present invention relates to an apparatus, a method, and a program for estimating an error in a projection angle of a projected image acquired by an X-ray CT apparatus.

### Description of the Related Art

In an X-ray CT, an angle of a gantry composed of an X-ray irradiation section and a detection section with respect to a sample is controlled, and a projected image is acquired at each angle. Then, by reconstructing an image with the acquired projected images, an internal structure of a sample can be observed. However, if the actual projection angle deviates from the control value, the quality of the reconstructed image deteriorates.

Therefore, a technique of measuring the projection angle position using an encoder or a sensor and correcting the deviation of the projection angle has been known (for example, refer to Patent Document 1). In the X-ray CT apparatus described in Patent Document 1, an actual projection angle is estimated using an optical camera.

Techniques for specifying a deviation of a projection angle using a reconstructed image are also known (for example, refer to Patent Document 2 and Non-Patent Document 1). According to Patent Document 2, in a CT image generating apparatus for charged particle beam therapy, presence or absence of an arc-shaped artifact is visually determined, and a deviation of a projection angle is detected.

According to Non-Patent Document 1, a TV (Total Variation) value is used as an index for estimating an error of a projection angle, which is measured by 180 degrees scan with a synchrotron. Thus, it is possible to correct the uniform deviation of the projection angle step.

### PATENT DOCUMENTS

Patent Document 1: JP-A-2012-112790
Patent Document 2: JP-A-2014-018522

### Non-Patent Document

[Non-patent Document 1] “Correction of center of rotation and projection angle in synchrotron X-ray computed tomography”, C-C. Cheng et al., Scientific Reports volume 8, Article number: 9884 (2018), https://www.nature.com/articles/s41598-018-28149-8

However, the design that incorporate encoders and sensors into the device is costly. In addition, when presence or absence of an artifact is visually determined, the result depends on a skill of the worker and is not stable. In the case of using a TV value, it is difficult to search for the minimal value because the increase of artifacts due to blurring of an image and the decrease of contrast of edges are detected at the same time.

### SUMMARY OF THE INVENTION

The present invention has been made in view of such circumstances, and an object thereof is to provide an angle error estimating apparatus, a method and a program capable of estimating the error of the projection angle with high accuracy at low cost.

(1) In order to achieve the above object, the angle error estimating apparatus of the present invention comprises a storing section for storing a series of projection data of an X-ray CT and control values of projection angles respectively associated with the projection data; a temporary correction section for correcting the control values of the projection angles to temporary correction values with an error model using an assumed parameter; a temporary reconstruction section for reconstructing a plurality of temporarily corrected images using the temporary correction values of the projection angles for each of different projection data sets composed of a part of the series of projection data; a consistency evaluating section for evaluating consistency of the plurality of temporarily corrected images; and a parameter determining section for determining an optimum parameter used for the error model based on the evaluated consistency.

(2) Further, in the angle error estimating apparatus of the present invention, sections to which the control values of the projection angles associated with the different projection data sets belong corresponds to a pair in which angular difference of centers of the respective sections is maximum.

(3) Further, in the angle error estimating apparatus of the present invention, the control values of the projection angles associated with the different projection data sets belong to three or more different sections.

(4) Further, in the angle error estimating apparatus of the present invention, the temporary correction section corrects the control value of the projection angle to a temporary correction value for the assumed parameter changed by a predetermined algorithm, the consistency evaluating section repeats evaluating the consistency for each of the assumed parameters changed, and the parameter determining section determines the assumed parameter used when the evaluation of the consistency is highest as an optimum parameter.

(5) Further, in the angle error estimating apparatus of the present invention, the error model varies an error non-uniformly with respect to time.

(6) Further, in the angle error estimating apparatus of the present invention, the error model is a periodic function defining an error with respect to time.

(7) Further, in the angle error estimating apparatus of the present invention, the temporary reconstruction section reconstructs the temporarily corrected image in a central cross section of the X-ray CT.

(8) Further, in the angle error estimating apparatus of the present invention, the parameter determining section determines the optimum parameter using a priori information with respect to variation of pixel values in the temporarily corrected image when there is a plurality of combinations of parameters corresponding to an optimum solution in the error model.

(9) Further, the angle error correcting apparatus of the present invention comprises a correction executing section for correcting the control value of the projection angle with respect to an error calculated by the error model using the optimum parameter determined by the angle error estimating apparatus according to any one of (1) to (8).

(10) Further, the angle error estimating method of the present invention comprises the steps of acquiring a series of projection data of an X-ray CT and control values of projection angles respectively associated with the projection data; correcting the control values of the projection angles to temporary correction values with an error model using an assumed parameter; reconstructing a plurality of temporarily corrected images using the temporary correction values of the projection angles for each of different projection data sets composed of a part of the series of projection data; evaluating consistency of the plurality of temporarily corrected images; and determining an optimum parameter used for the error model based on the evaluated consistency.

(11) Further, the angle error estimating program of the present invention causes a computer to execute processes of acquiring a series of projection data of an X-ray CT and control values of projection angles respectively associated with the projection data; correcting the control values of the projection angles to temporary correction values with an error model using an assumed parameter; reconstructing a plurality of temporarily corrected images using the temporary correction values of the projection angles for each of different projection data sets composed of a part of the series of projection data; evaluating consistency of the plurality of temporarily corrected images; and determining an optimum parameter used for the error model based on the evaluated consistency.

### BRIEF DESCRIPTION OF THE DRAWINGS

FIGS. 1A to 1C are a perspective view showing a control mechanism for the projection angle, a graph showing an error with respect to the control value, a graph showing the projection angle with respect to the driving time (t), respectively.

FIGS. 2A and 2B are a schematic diagram showing the projection angle with respect to the control angle and a graph showing the projection angle (θ) with respect to the driving time (t), respectively.

FIGS. 3A and 3B are diagrams showing ranges of control angles of the projection data sets, respectively.

FIG. 4 is a schematic diagram showing the X-ray CT system.

FIG. 5 is a block diagram showing an angle error estimating apparatus.

FIG. 6 is a flowchart showing an angle error estimating method.

FIG. 7 is a sequence chart showing an angle error estimating method.

FIG. 8 is a diagram showing an example of input screen.

FIGS. 9A and 9B are diagrams showing examples of display screens, respectively.

FIG. 10 is a schematic diagram showing a relationship between an index and a priori information with respect to a parameter.

FIG. 11 is a graph showing a consistency index with respect to parameters.

FIGS. 12A and 12B are a reconstructed image and a graph of the CT-value with respective to the position before correction, respectively.

FIGS. 13A and 13B are a reconstructed image and a graph of the CT-value with respective to the position after correction, respectively.

### DETAILED DESCRIPTION OF THE INVENTION

Next, embodiments of the present invention are described with reference to the drawings. To facilitate understanding of the description, the same reference numerals are assigned to the same components in the respective drawings, and duplicate descriptions are omitted.

[Principle]

An X-ray CT apparatus irradiates a sample with a cone-shaped or parallel beam of X-rays from any angle, and acquires a distribution of absorption coefficient of the X-rays, that is, a projected image, by a detector. To irradiate X-rays from any angle, the X-ray CT apparatus is configured to rotate a sample stage with respect to the fixed X-ray source and the detector or to rotate the gantry integrated with X-ray source and the detector. The rotation is relative, and a rotation angle refers to an angle between the gantry and the sample, and is also referred to as a projection angle. Incidentally, the rotation angle is basically proportional to rotation driving time.

Thus, projection is performed from various angles and the distribution of linear absorption coefficient of the sample can be inferred from the contrast of the projected images of the sample acquired. Then, it is called reconstruction that a three-dimensional linear absorption coefficient distribution is acquired from two-dimensional projected images. Basically, backprojection of the projected images is performed.

For measurements with the parallel beam method, the range of projection angles required for reconstruction is 180°. When measuring by 360° scan, if consistency is ensured, reconstructed images of any 180° sections will be identical. However, the actual projection angle is different from the ideal control angle (control value of the projection angle) when error propagation due to the driving components of the apparatus or the electrical signals occurs.

Since the information of the control angles is used for the reconstruction of the projected images acquired respectively at the projection angles, the reconstructed image is blurred because the back projection is performed at angles different from the actual projection angles when the reconstruction is performed in a state with an error. In a correction method to evaluate the consistency, the parallel beam method is basically assumed. In a case of an apparatus using the cone beam method, the consistency can be evaluated on the central cross section of the reconstructed image as well as that in the case of the parallel beam method.

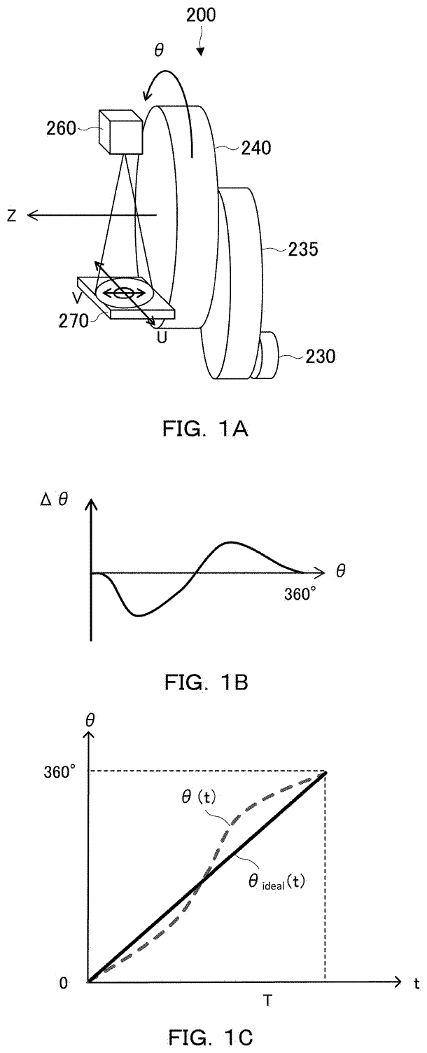

FIGS. 1A to 1C are a perspective view showing a control mechanism for the projection angle, a graph showing an error with respect to the control value, a graph showing the projection angle with respect to the driving time (t), respectively. As shown in FIG. 1A, the X-ray CT apparatus 200 transmits the driving force of the motor 230 to the gantry 240 via the belt 235. As the gantry 240 rotates, the X-ray irradiation section 260 and the detection section 270 rotate around the sample. In FIG. 1A, Z-axis as the CT rotation axis, V-axis as the direction parallel to the CT rotation axis on the detector, and U-axis as the direction perpendicular to the V-axis are expressed, therefor the central cross section of the reconstructed image (Z=0 cross section) is projected on the U-axis.

In the case of such a mechanism, even if the motor 230 performs a uniform rotational operation, the projection angles vary non-uniformly due to mechanical errors arising from gears, belts, and the like. For example, delays in the transmission of driving forces by such as a rubber belt, can cause the angles to deviate non-uniformly. FIG. 1A shows the vicinity of θ=180° (the state where the source is vertically on the upper side) when the rotational angle of the gantry is expressed as θ. In the case, the actual rotation angle can be inferred to be smaller than the ideal rotation angle when rotating the X-ray irradiation section 260 to the vertical upper side (θ=0 to 180°), and the actual rotation angle can be inferred to be larger than the ideal rotation angle when rotating the X-ray irradiation section 260 to the vertical lower side (θ=180 to 360°).

The deviation (Δθ) of the projection angle with respect to the control angle (θ) of the gantry in the case can be shown so as in FIG. 1B. Further, the actual projection angle (θ(t)) with respect to the driving time (t) of the gantry is a value affected by the deviation of the projection angle with respect to the control value (θ_{ideal}(t)) of the gantry, as indicated with a broken line in FIG. 1C.

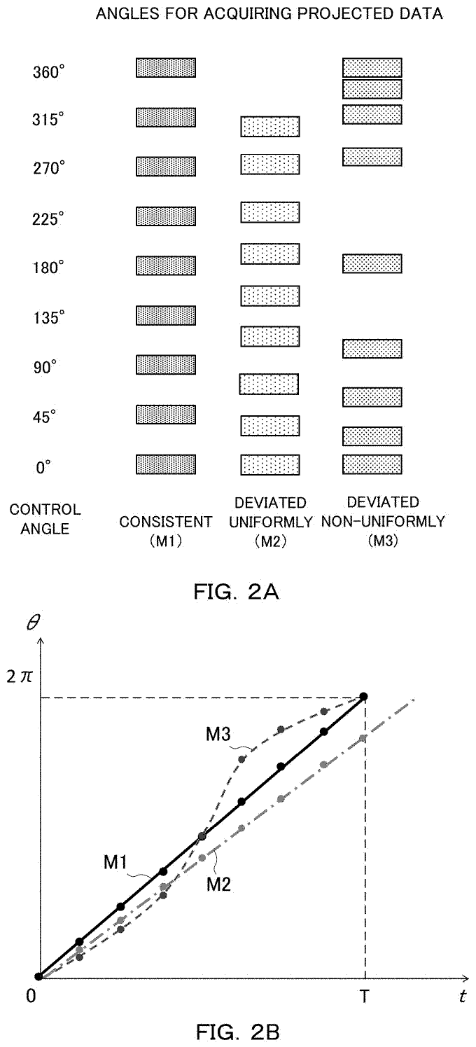

FIGS. 2A and 2B are a schematic diagram showing the projection angle with respect to the control angle and a graph showing the projection angle (θ) with respect to the driving time (t), respectively. The plots (points) on the lines in FIG. 2B correspond to the angles acquiring the projection data in FIG. 2A. For example, in the projection data set M1 with no error between the control angle and the actual projection angle, the relationship of the projection angle with respect to the control angle is represented by a straight line M1 on the graph. In contrast, in the projection data set M2 in which the projection angle deviates uniformly from the control angle, the relationship is represented by a straight line M2 on the graph, but the slope of the straight line M2 is smaller than the slope of the straight line M1. Further, in the projection data set M3 in which the projection angle deviates non-uniformly from the control angle, the relationship is represented as a periodic curve centered on the straight line M1 on the graph.

In the present invention, a non-uniform variation in such a projection angle is represented by an error model. For example, it is preferable to approximate the error model with a periodic function like a Fourier series expansion. For example, if the actual angle position is deviated by A from the ideal angle position, A is given in a Fourier series expansion as in the following equation. In addition to Fourier series expansion, the power series expansion and spline function can be used as the error model.

$$Δ θ ( t ) = {\sum }_{j = 1}^{{j}_{max}} {A}_{j} sin j {θ}_{ideal} ( t ) + {\sum }_{k = 0}^{{k}_{max}} {B}_{k} cos k {θ}_{ideal} ( t ) \qquad ( 1 )$$

Here, the parameter Aⱼ and Bₖ of the error model represent the amplitudes of the periodic functions, and by optimizing the two parameters, a function for calculating the angle error can be determined. jₘₐₓ and kₘₐₓ represent orders of periodic functions and are fixed values that can be arbitrarily determined by the assumed error model.

If the main factor of the error of the projection angle is elongation and contraction of the belt, the error increases with increase of load to the belt in the projection angle around 90° and 270°. When such assumptions hold, it is reasonable to set the error models as first-order periodic functions with jₘₐₓ and kₘₐₓ set to 1 as in Equation (2). The projection angles may be step angles of discrete angles (θ_{ideal, i}) correlated with the number of projected images, where i is the label of the projected image, and np is the number of projected images. In addition, a boundary condition may be set to define that there is no error at the initial time. Thus, by specifying the error factors that may appear in the used X-ray CT apparatus and limiting the error model, it is possible to reduce the parameters. As a result, the calculation time can be shortened.

Δθᵢ=−A sin θ_{ideal,i}−B(cos θ_{ideal,i}−1) (2)

θ_{ideal,i}=i*360°/np

i=0,1, . . . nₚ−1

Boundary Condition Δθᵢ₌₀=0

Parameters of the error model as represented by Equations (1) and (2) are changed and optimized using an index (evaluation function) of the consistency degree between the reconstructed images obtained from the projected images respectively for the sections of the projection angles. By determining the parameters of the error model in the optimization, the deviation amount of the projection angle is calculated. Then, the projection angle at the time of measurement is estimated by correcting the deviation amount calculated with respect to the control angle.

Specifically, the angle range of the projection angle with which the reconstructed image is formed with the assumed error is determined. The consistency of the sinogram is evaluated by using the difference of reconstructed images for the evaluation function using multiple different 180° sections among the angle range of 360°. For example, reconstruction (half reconstruction) is performed by using the projected images acquired in the angle range of 180°+ fan angles. Then, the reconstructed image is generated using the projected image data set included in the set section range.

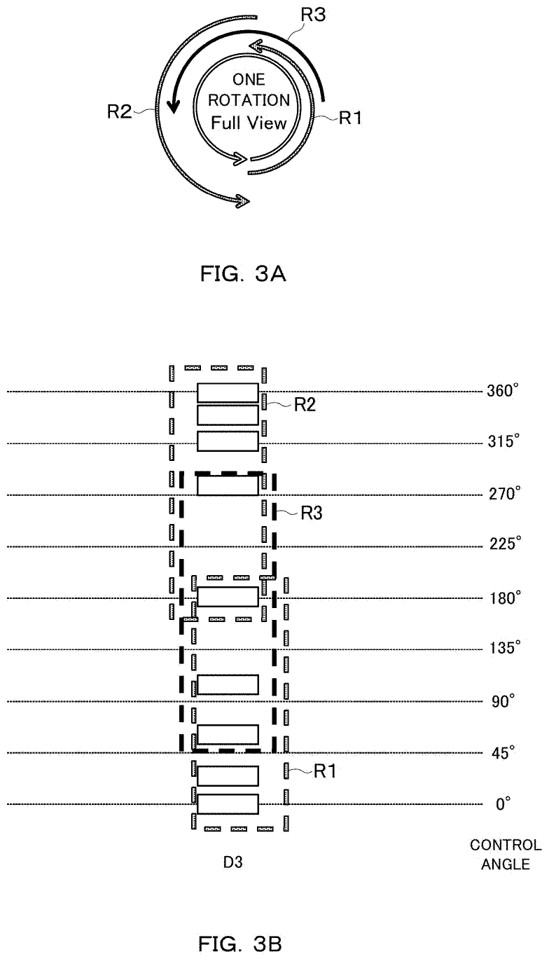

FIGS. 3A and 3B are diagrams showing ranges of control angles of the projection data sets, respectively. The ranges R1 to R3 are set based on the control positions, and the reconstructed images are generated with the projection data sets corresponding to the set ranges R1 to R3 based on the assumed error.

An evaluation function can be used to optimize the error model. For example, for projection angles over 360°, a plurality of reconstructed images corresponding to the different sections in the same angle range are generated, and two of the plurality of reconstructed images are used as a pair. The consistency degree of the pair is calculated, and a value acquired by adding the consistency degrees of all the pairs can be used as an evaluation function. That is, the evaluation function can be defined by the addition of MSE as follows. In the present invention, an evaluation function such as a consistency index (CI) is used as an evaluation index of the error model.

$$Consistency index = {\sum }_{i < j}^{n} MSE ( i , j ) \qquad ( 3 )$$

$$MSE ( i , j ) = \frac{1}{M} {\sum }_{m = 1}^{M} {( {f}_{m}^{i} - {f}_{m}^{j} )}^{2} \qquad ( 4 )$$

Incidentally, n in Equation (3) is the number of sections, the sum means to add only for the number of combinations (ₙC₂=n (n−1)/2). Also, i and j in Equation (4) indicate the number of the projected image data sets for generating the reconstructed images. A MSE (Mean Squared Error) also indicates the square mean value of the differences of pixel values f for all pixels (total number of pixels M) around the central cross section of the reconstructed image corrected with the assumed error. Incidentally, a SSIM (Structure Similarity), an area, and a Mutual Information (MI) may be used instead of the MSE when defining the evaluation function.

The parameters of the error model in which the above-mentioned evaluation function takes a minimal value are searched for. As an optimization method, a range search, a simplex method, a gradient method, or the like can be adopted. For example, when the range search is performed, search ranges are set for the parameters A and B of the error model. The search range can be set by, for example, specifying the minimum value, the maximum value, and the step of the parameter. The consistency degree is calculated by an evaluation function for each combination of the parameters A and B. If there is no error in the projection angle, the evaluation function takes an extreme value. The combination of which the consistency degree takes a minimal value is determined for parameters of the error model.

The parameters of the error model may be changed until they match by the gradient method, but the search may converge to a local optimum solution. When there is a plurality of combinations of parameters corresponding to the optimum solution of the parameters extracted by the search, the local optimum solution and the global optimum solution coexist. In this case, it is preferable to determine a reasonable solution as a global optimum solution by referring also to a priori information.

For example, optimization with high-order terms of Fourier series expansion in only two angle ranges, 0-180° and 180-360°, yields multiple solutions with the same value of the valuation function. By using a priori information, instability of such results can be avoided, and the solutions can be distinguished.

[Whole System]

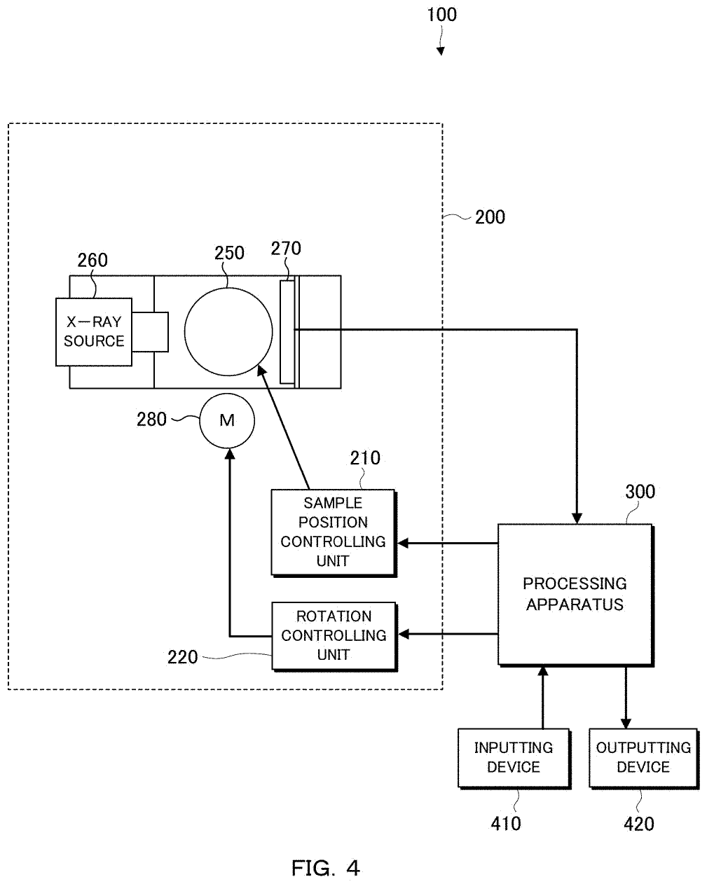

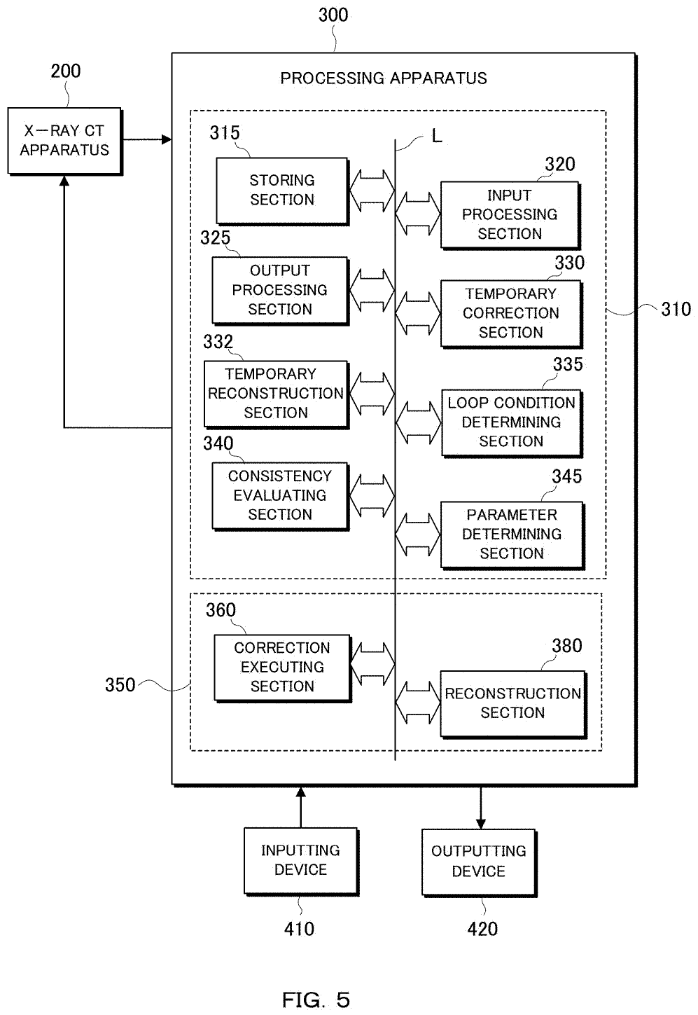

FIG. 4 is a schematic diagram showing an X-ray CT system 100. The X-ray CT system 100 comprises an X-ray CT apparatus 200 and a processing apparatus 300. The processing apparatus 300 functions as an angle error estimating apparatus and an angle error correcting apparatus. Here, the X-ray CT apparatus 200 shown in FIG. 5 is configured to rotate the gantry in which the X-ray irradiation section 260 and the detection section 270 are integrated with respect to the sample, but the present invention is not limited thereto, and may be configured to rotate the sample.

The processing apparatus 300 (angle error estimating apparatus) is connected to the X-ray CT apparatus 200 performs processing of the control and acquired data of the X-ray CT apparatus 200. The processing apparatus 300 may be a PC terminal or a server on a cloud. The inputting device 410 is, for example, a keyboard or a mouse, and performs input to the processing apparatus 300. The outputting device 420 is, for example, a display, and is used for displaying a result of processing by the processing apparatus 300 to a user by a display screen or the like.

[X-Ray CT Apparatus]

As shown in FIG. 5, the X-ray CT apparatus 200 comprises a sample position controlling unit 210, a rotation controlling unit 220, a sample stage 250, an X-ray irradiation section 260 and a detection section 270. The X-ray irradiation section 260 and the detection section 270 are installed in a gantry, and X-ray CT imaging is performed by rotating the gantry with respect to a sample fixed to the sample stage 250.

The X-ray CT apparatus 200 rotates the gantry at a timing instructed by the processing apparatus 300 and acquires projected images of the sample. The measurement data is transmitted to the processing apparatus 300. Though the X-ray CT apparatus 200 is suitable for use for precision industrial products such as semiconductor devices, it can be applied to an apparatus for animals as well as an apparatus for industrial products.

The X-ray irradiation section 260 irradiates X-rays toward the detection section 270. The detection section 270 is a two-dimensional detector, has a receiving surface for receiving X-rays and can measure the intensity distribution of X-rays transmitted through the sample by a large number of pixels. The X-ray CT projected images are preferably acquired with a two-dimensional detector having detection elements of 50 μm or less, e.g. pixels of 50×50 μm or less.

For example, when the enlargement ratio becomes 50 times, the size of one pixel becomes 1 μm. The present invention is effective for the X-ray CT apparatus of the industrial product in which the analysis is carried out with the precision of micron order especially, because an error occurs in recognizing the shape and measuring the dimension when an image blur of micron order is caused by the angle error.

The sample position controlling unit 210 controls the sample position before the CT measurement by adjusting the position of the sample stage 250. The rotation controlling unit 220 rotates the gantry at a speed set at the time of CT measurement.

[Processing Apparatus]

FIG. 5 is a block diagram showing the angle error estimating apparatus. The processing apparatus 300 is configured by a computer formed by connecting a CPU (Central Processing Unit), a ROM (Read Only Memory), a RAM (Random Access Memory), and a memory to a bus. The processing apparatus 300 is connected to the X-ray CT apparatus 200 and receives information.

The processing apparatus 300 comprises a storing section 315, an input processing section 320, an output processing section 325, a temporary correction section 330, a temporary reconstruction section 332, a loop condition determining section 335, a consistency evaluating section 340, a parameter determining section 345, a correction executing section 360, and a reconstruction section 380. Each of the sections can transmit and receive information via the control bus L. The inputting device 410 and the outputting device 420 are connected to the CPU via an appropriate interface.

The storing section 315, the input processing section 320, the output processing section 325, the temporary correction section 330, the temporary reconstruction section 332, the loop condition determining section 335, the consistency evaluating section 340, and the parameter determining section 345 constitute the angle error estimating apparatus 310. The correction executing section 360 and the reconstruction section 380 constitute the angle error correcting apparatus 350. The angle error estimating apparatus 310 and the angle error correcting apparatus 350 may be provided as separate processing apparatuses. In any case, the apparatuses are connected to each other so that information can be transmitted and received.

The storing section 315 stores a series of projection data of the X-ray CT and the control values of projection angle associated with each of the projection data. The storing section 315 also stores the conditions of the error estimating process, the optimum parameters, the angle errors, and the reconstructed images. The input processing section 320 performs processing to input information to the processing apparatus 300. The output processing section 325 performs processing to output information from the processing apparatus 300.

The temporary correction section 330 calculates an error by the error model using the assumed parameter and corrects the control value of the projection angle to the temporary correction value. The temporary correction section 330 calculates the errors using parameters different respectively for loops by changing the parameters in a predetermined algorithm at the time of the loop.

The temporary reconstruction section 332 generates a plurality of reconstructed images (temporarily corrected images) using the temporary correction values of the projection angles for each of the different projection data sets composed of a part of a series of projection data. The sections to which the control angles associated with the different projection data sets belong is preferably a pair in which the difference of the respective angular centers is maximized. By pairing the projection data sets so as to reduce the number of overlapping projected images, the consistency within the range of projection angles can be efficiently evaluated.

The control values of the projection angles associated with the different projection data sets can be set so as to belong to three or more different sections. For example, if the angle error occurs in the cycle of 180° and the period matches the section of the two projection data sets, the same angular deviation occurs in the reconstructed images generated respectively by the projection data sets. In that case, if only two sections are used, the pixel values of the reconstructed images being compared seem to be consistent because the same angular deviation occurs. Therefore, a plurality of solutions having the same value of the evaluation function can be derived. Since the effect of different angle deviations can be assessed by setting the three sections, the solutions can be distinguished by the used evaluation function. Thus, by increasing the number of data sets, it is possible to distinguish between optimum solutions that cannot be distinguished between two projection data sets.

The temporary reconstruction section 332 preferably reconstructs the temporarily corrected image in the central cross section of the X-ray CT. In the X-ray CT apparatus using a cone beam, the further away from the rotation center, the larger the error originated from the cone beam. By using a temporarily corrected image of the central cross section, the error originating from the cone beam can be suppressed and the angle error can be estimated accurately. Although the consistency evaluating section 340 may evaluate the consistency using the central cross section of the three-dimensional temporarily corrected image, it is more efficient to reconstruct only the temporarily corrected image of the central cross section.

When the parallel beam method (fan beam method) is used, an image of any position can be used as same as an image of the central cross section.

The loop condition determining section 335 determines whether or not the loop is completed according to the optimization method. When the loop is not completed, the loop condition determining section 335 changes the parameters in accordance with the setting and causes each of the sections to execute the error calculation and consistency evaluation processing. When the loop is completed, the loop condition determining section 335 causes the parameter determining section 345 to determine an optimum parameter.

The consistency evaluating section 340 evaluates the consistency of a plurality of temporarily corrected images. The consistency evaluating section 340 repeats the consistency evaluation for each of the parameters assumed for each loop. Thus, because the consistency of the temporarily corrected images in the sections of the different projection angles is evaluated, the present embodiment is suitable when the error model which varies the error non-uniformly with respect to time can be applied. For example, it is referred the case that non-uniform mechanical errors may occur from gears, belts, or the like.

In the above case, it is preferable to use a periodic function of the error with respect to time as the error model. Thus, the number of parameters can be reduced, and the calculation time can be shortened by estimating the error factors to set the error model. The use of the periodic function is particularly effective in the case where the periodic error is non-uniform, and even in the case where the variation of the error has a high frequency, which can be dealt with by assuming the order (j_max, k_max) of Equation (1) up to a high order.

The parameter determining section 345 determines an optimum parameter used for the error model based on the evaluated consistency. The parameter determining section determines the assumed parameter used when the consistency evaluation is highest as the optimum parameter. Thus, the optimum parameters can be surely determined.

With each of the above sections, the error of the projection angle can be acquired by calculation using a series of projection data without using an encoder or a sensor. For example, the projection angle can be corrected only by software correction for the apparatus where it is difficult to install an encoder.

Further, since the error is estimated by evaluating the consistency based on the plurality of temporarily corrected images, a stable result is obtained every time. As a result, the error of the projection angle can be estimated with high accuracy at low cost. Then, a high-quality reconstructed image with less blurring can be acquired by using the projection angles corrected with the errors.

The parameter determining section 345 preferably determines the optimum parameter using a priori information with regard to the variation of the pixel value in the temporarily corrected image according to the situation. For example, this method is effective when there is a plurality of combinations of parameters corresponding to the optimal solutions in the error model. By supplementarily using a priori information, a reasonable solution can be selected as a global optimum solution when there is a plurality of local optimum solutions.

The correction executing section 360 corrects the control value of the projection angle using the optimum parameter in the error model. Then, the corrected image is reconstructed from the series of projection data. Thus, the projection angle acquired by correcting the error is used to provide a high-quality corrected image with less blurring.

The reconstruction section 380 reconstructs a three-dimensional CT image based on a projection data set composing of a series of projected images and the projection angles associated with them. Further, the reconstruction section 380 generates a cross-sectional image of the three-dimensional CT image in response to an instruction.

[Measurement Method]

A sample to be measured is placed in the X-ray CT apparatus 200. The sample position is adjusted, X-rays are irradiated, and a CT scan is performed. The acquired projection data set composing of a series of projected images and the projection angles associated with them is sent to the processing apparatus 300, and the processing apparatus 300 stores the data set.

[Process]

(Processing Apparatus Operation)

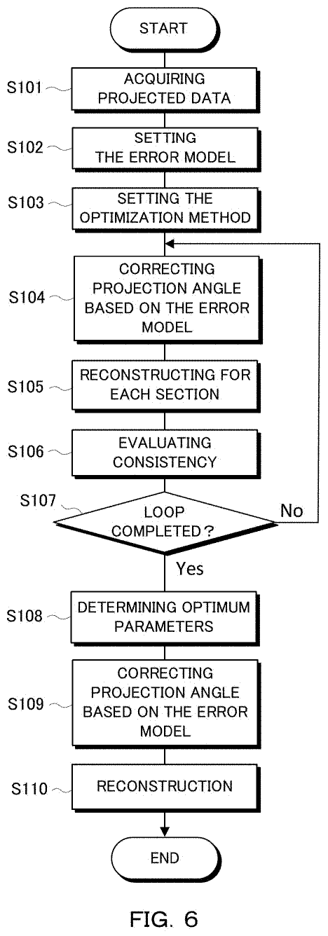

An angle error estimating method by the operation of the processing apparatus 300 configured as described above is described later. FIG. 6 is a flowchart showing an angle error estimating method. First, the processing apparatus 300 acquires the projection data and the control angles corresponding to them (step S101). Then, the error model and the optimization method used in estimating the error of the projection angle are set (steps S102 and S103). For example, the setting is performed by accepted user inputs. When the optimization method is set, each 180° section is set from the number of sections, and an evaluation function is also set. The setting for changing parameters is also performed.

Then, the correction amount is calculated by the set error model, and the projection angle is temporarily corrected (step S104). The temporarily corrected projection angle is used to reconstruct the temporarily corrected image with the projection data of the section of the set projection angles (step S105). In this case, it is preferable to perform reconstruction of only the central cross section of the X-ray CT from the viewpoint of efficiency.

The index is calculated using the evaluation function based on the acquired temporarily corrected image (step S106). It is determined whether or not the loop is completed (step S107). When the loop is processed while the parameters are changed by a predetermined algorithm, the completion of the loop can be determined by determining whether or not the algorithm is completed.

If the loop is not completed, the process returns to the step S104. When the loop is completed, the optimum parameter is determined by referring to the indices calculated so far (step S108). Then, the error is calculated with the error model using the optimum parameter, and the projection angle is corrected by eliminating the error (step S109). The CT image is reconstructed with all the projection data by the corrected projection angles (step S110), and the series of operations are finished.

(Information I/O and Processing)

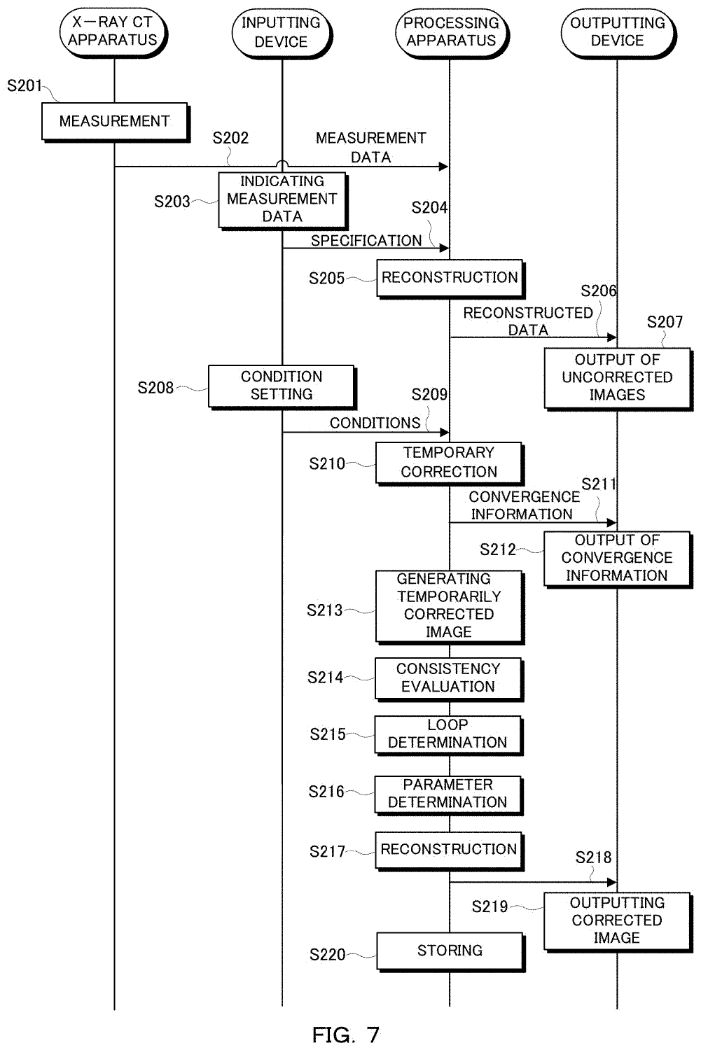

Next, the operation of each of the apparatuses described above is described focusing on the input and output of information. FIG. 7 is a sequence chart showing the angle error estimating method. First, in the X-ray CT apparatus 200, the sample is measured (step S201). The processing apparatus 300 acquires measurement data composing of a series of projection data acquired by one measurement (step S202). On the other hand, the inputting device 410 receives the indication of the measurement data from the user (step S203), and the processing apparatus 300 receives the indicating information from the inputting device 410 (step S204) and reads out the indicated measurement data.

The processing apparatus 300 reconstructs the CT image with the read measured data (step S205), sends the reconstructed data to the outputting device 420 (step S206), and the outputting device 420 outputs the reconstructed image as an uncorrected image (step S207).

The user confirms the output reconstructed image and instructs correction when there is blurring or the like in the image. First, the inputting device 410 receives input of condition setting from the user (step S208) and sends condition information to the processing apparatus 300 (step S209). The processing apparatus 300 starts the loop processing according to the condition.

The processing apparatus 300 calculates the error with the error model using the assumed parameters and temporarily corrects the control angle with the error (step S210). The processing apparatus 300 sends the convergence information of the loops to the outputting device 420 (step S211), and the outputting device 420 outputs the convergence information (step S212). The user can confirm the situation of error estimation by the convergence information.

The temporarily corrected image is reconstructed using the corrected projection angles and measured data acquired by the temporary correction (step S213), and the consistency is evaluated (step S214). The evaluation result of consistency is acquired as an index. Then, it is determined whether or not the condition for completing the loop is satisfied (step S215). If the condition for completing the loop is not satisfied, the process returns to the step S210 to repeat the loop. If the condition for completing the loop is satisfied, the optimum parameter is determined (step S216).

Using the determined optimum parameters, the projection angles are corrected so as to eliminate the errors calculated by the error model, and the reconstructed image is generated with the corrected projection angles (step S217). The processing apparatus 300 sends the reconstructed image acquired by the correction to the outputting device 420 (step S218), and the outputting device 420 outputs the reconstructed image (step S219). The processing apparatus 300 stores the optimum parameters (step S220). The optimum parameters are stored because they can also be used for other measurements. Further, the corrected projection angles may be stored. In this manner, a series of processing is completed.

(Input Information)

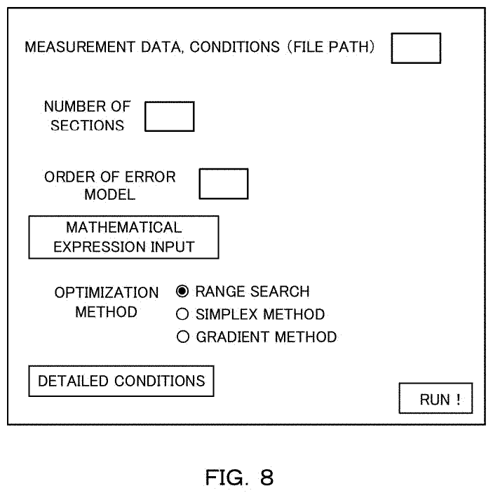

FIG. 8 is a diagram showing an example of input screen. In the step S208 described above, the user can enter the condition setting on the input screen. Specifically, the specification of the measurement data, the number of sections of the projection angles to generate the temporarily corrected image, the mathematical expression of the error model and the optimization method can be input.

As the mathematical expression of the error model, it is preferable to enable specifying the order of Fourier series or directly entering the mathematical expression. As an optimization method, for example, it is preferable to enable selecting one among the range search method, the simplex method, or the gradient method, and inputting detailed conditions of the selected method.

(Output Information)

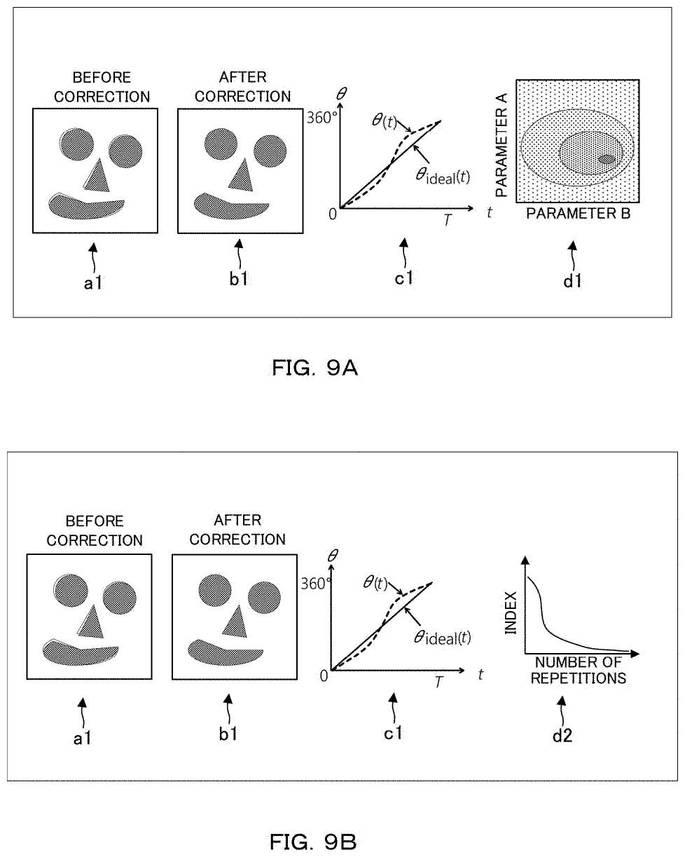

FIGS. 9A and 9B are diagrams showing examples of display screens, respectively. On the display screen, for example, the reconstructed images a1 and b1 before and after correction, the estimated projection angle information c1, and the convergence information d1 and d2 are output. It is preferable to simultaneously display the reconstructed image a1 before correction and the reconstructed image b1 after correction in order to make it possible to confirm the effect of correction.

The estimated projection angle information c1 is easy to understand if displayed as a projection angle with respect to time as shown in FIGS. 9A and 9B. The angle error may be coarsely or densely represented on the circumference. In that case, it is easy to understand which angular position the deviation is large.

As the convergence information, a graph showing the degree of convergence can be displayed. For example, when the range search is performed as an optimization method, an index of consistency with respect to a parameter such as the convergence information d1 can be displayed. When the simplex method is performed as the optimization method, an index of consistency with respect to the number of repetitions such as the convergence information d2 can be displayed.

(A Priori Information)

When the consistency is evaluated and the optimum parameter is determined, not only an evaluation function such as a consistency index is used as an evaluation index of the error model, but also a priori information may be referred to. For example, it is preferable to use information such as a large number of straight-line portions and a large number of flat portions of the reconstructed image as a priori information. A priori information includes a TV (Total Variation), a histogram, and a cross-sectional area of the sample shape.

The TV becomes large when the boundary of the sample shape is clear. The histogram changes sharply when the boundary of the sample shape is clear. The cross-sectional area of the sample shape corresponds to the number of pixels contributing to the area and increases when blurring occurs in the image.

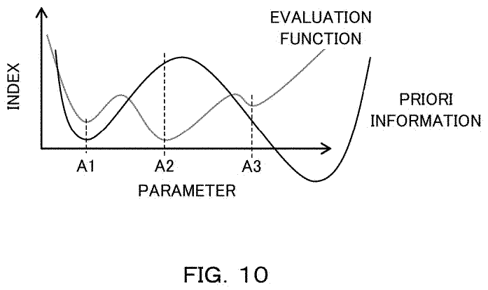

FIG. 10 is a schematic diagram showing a relationship between an index and a priori information with respect to a parameter. As shown in FIG. 10, when an evaluation function such as MSE is calculated for a certain parameter as an evaluation index of the error model, a plurality of optimum parameter candidates A1 to A3 may be generated as extreme values. In the case, since a priori information such as a TV is the smallest with the parameter A1 among the candidates A1 to A3, the parameter A1 can be determined as the optimum parameter. However, since the extreme value of a priori information does not correspond to the solution, the parameter cannot be optimized by using only the priori information.

### Example 1

The chart for X-ray CT was measured as a subject, and the consistency of the temporarily corrected image was evaluated using Equation (2) as an error model to estimate the error, and the reconstructed images before and after the correction were compared. In CT measurement, for a range of projection angles of 0 to 360°, the number of projected images was set to 803 (np=803), and the projected images were acquired. The unit of parameters A and B is the step angle (360°/803). For each combination of the parameters A and B in Equation (2), the consistency index in Equation (3) was calculated, and the distribution of the index values was output as a color map.

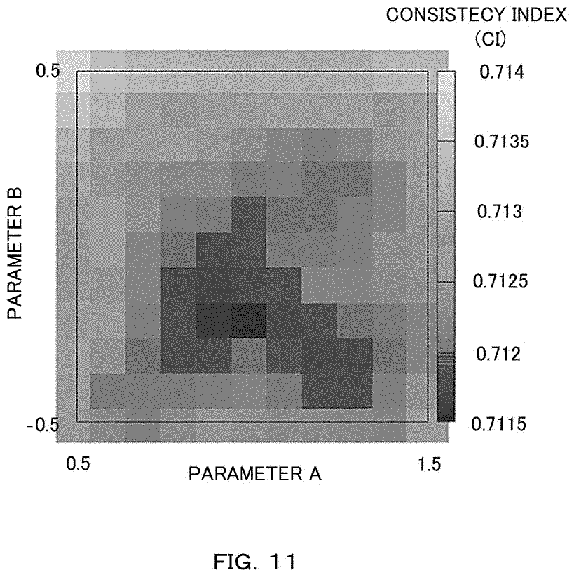

FIG. 11 is a graph showing the consistency index with respect to the parameters. As shown in FIG. 11, as a result of evaluating the consistency of a plurality of temporarily corrected images for each loop, the index was a minimal value when the parameter A was 1.0 and the parameter B was −0.2. The optimized parameters A and B were substituted into Equation (2) to determine the function for calculating the angle error. Further, the correction amount of the reconstructed image was calculated using the determined function.

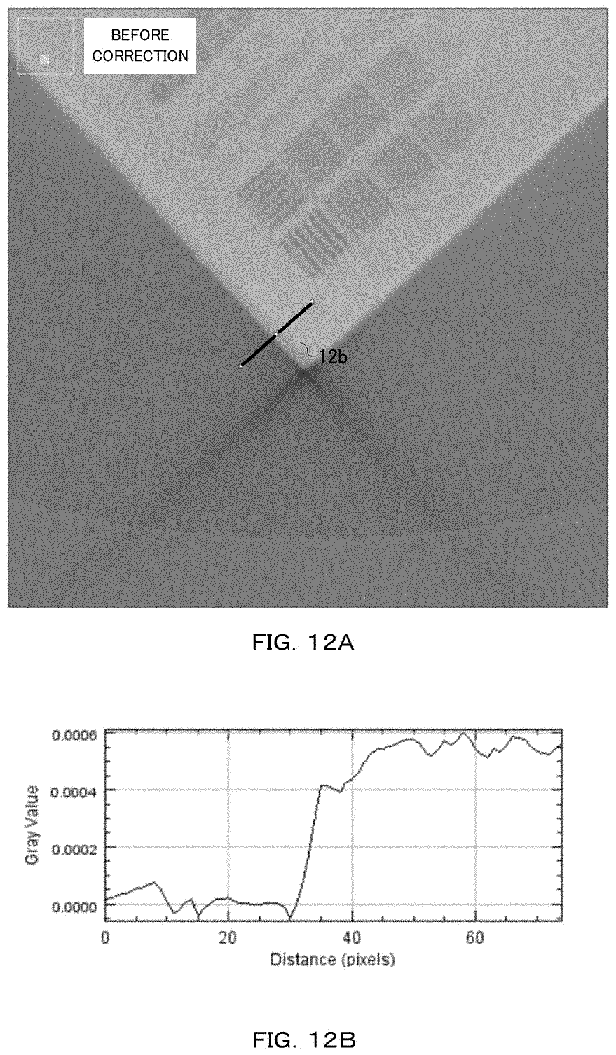

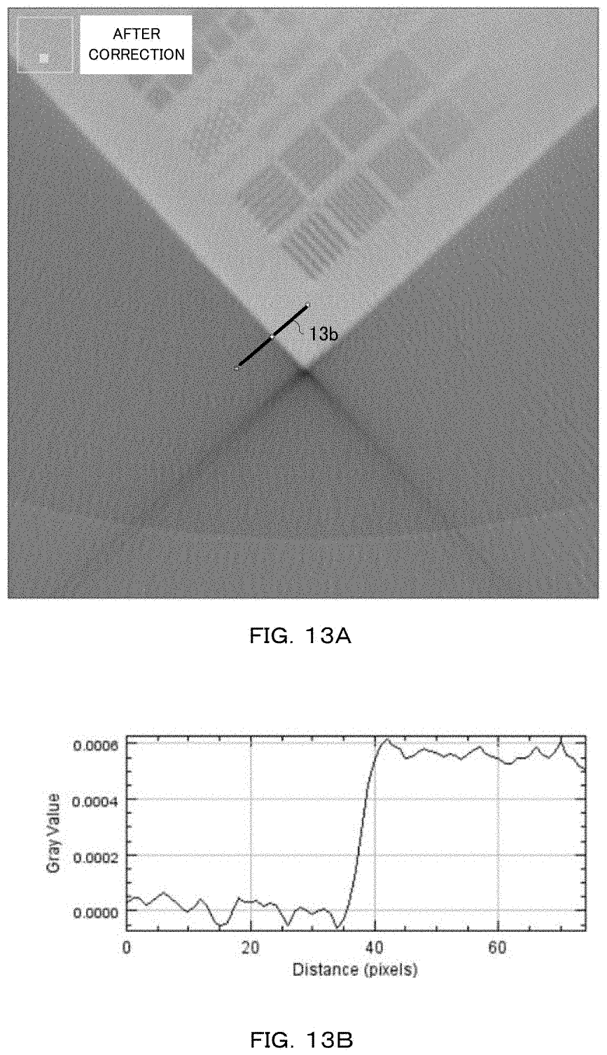

FIGS. 12A and 12B are the reconstructed image and a graph of the CT value with respect to the position before correction, respectively. The line segment 12b in FIG. 12A corresponds to the horizontal axis in FIG. 12B. FIGS. 13A and 13B are the reconstructed image and a graph of the CT value with respect to the position after correction, respectively. The line segment 13b in FIG. 13A corresponds to the horizontal axis in FIG. 13B.

In the reconstructed image before correction shown in FIG. 12A, the edges of the charts are blurred. The presence of blur can also be confirmed by the fact that the slope continues from distance 30 to distance 45 in FIG. 12B and a small peak of CT value appears at the position of distance 35.

On the other hand, in the reconstructed image after correction shown in FIG. 13A, the edges of the charts are clearly displayed, and blurring cannot be confirmed. In FIG. 13B as well, the slope continues from distance 35 to distance 42. From the above, it has been proved that the reconstructed image where the error is eliminated can be acquired by estimating the error of the projection angle with high accuracy by the angle error estimating method of the present invention.

Incidentally, this application claims priority under Japanese Patent Application No. 2021-106771 filed on Jun. 28, 2021, and the entire contents of Japanese Patent Application No. 2021-106771 are incorporated by reference in this application.

### DESCRIPTION OF SYMBOLS

100 X-ray CT system
200 X-ray CT apparatus
210 sample position controlling unit
220 rotation controlling unit
230 motor
235 belt
240 gantry
250 sample stage
260 X-ray irradiation section
270 detection section
300 processing apparatus
310 angle error estimating apparatus
315 storing section
320 input processing section
325 output processing section
330 temporary correction section
332 temporary reconstruction section
335 loop condition determining section
340 consistency evaluating section
345 parameter determining section
350 angle error correcting apparatus
360 correction executing section
380 reconstruction section
L control bus
410 inputting device
420 outputting device
a1, b1 reconstructed image
c1 projection angle information
d1, d2 convergence information
M1 to M3 projection data set (collection of data points on each graph)
R1 to R3 range of projection angles

What is claimed is:

1. An angle error estimating apparatus, comprising:
a storing section for storing a series of projection data of an X-ray CT and control values of projection angles respectively associated with the projection data,
a temporary correction section for correcting the control values of the projection angles to temporary correction values with an error model using an assumed parameter,
a temporary reconstruction section for reconstructing a plurality of temporarily corrected images using the temporary correction values of the projection angles for each of different projection data sets composed of a part of the series of projection data,
a consistency evaluating section for evaluating consistency of the plurality of temporarily corrected images, and
a parameter determining section for determining an optimum parameter used for the error model based on the evaluated consistency.

2. The angle error estimating apparatus according to claim 1, wherein
sections to which the control values of the projection angles associated with the different projection data sets belong corresponds to a pair in which angular difference of centers of the respective sections is maximum.

3. The angle error estimating apparatus according to claim 1, wherein
the control values of the projection angles associated with the different projection data sets belong to three or more different sections.

4. The angle error estimating apparatus according to claim 1, wherein
the temporary correction section corrects the control value of the projection angle to a temporary correction value for the assumed parameter changed by a predetermined algorithm,
the consistency evaluating section repeats evaluating the consistency for each of the assumed parameters changed, and
the parameter determining section determines the assumed parameter used when the evaluation of the consistency is highest as an optimum parameter.

5. The angle error estimating apparatus according to claim 1, wherein
the error model varies an error non-uniformly with respect to time.

6. The angle error estimating apparatus according to claim 5, wherein
the error model is a periodic function defining an error with respect to time.

7. The angle error estimating apparatus according to claim 1, wherein
the temporary reconstruction section reconstructs the temporarily corrected image in a central cross section of the X-ray CT.

8. The angle error estimating apparatus according to claim 1, wherein
the parameter determining section determines the optimum parameter using a priori information with respect to variation of pixel values in the temporarily corrected image when there is a plurality of combinations of parameters corresponding to an optimum solution in the error model.

9. An angle error correcting apparatus comprising a correction executing section for correcting the control value of the projection angle with respect to an error calculated by the error model using the optimum parameter determined by the angle error estimating apparatus according to claim 1.

10. An angle error estimating method, comprising steps of:
acquiring a series of projection data of an X-ray CT and control values of projection angles respectively associated with the projection data,
correcting the control values of the projection angles to temporary correction values with an error model using an assumed parameter,
reconstructing a plurality of temporarily corrected images using the temporary correction values of the projection angles for each of different projection data sets composed of a part of the series of projection data,
evaluating consistency of the plurality of temporarily corrected images, and
determining an optimum parameter used for the error model based on the evaluated consistency.

11. A non-transitory computer readable recording medium having recorded thereon an angle error estimating program, causing a computer to execute processes of:
acquiring a series of projection data of an X-ray CT and control values of projection angles respectively associated with the projection data,
correcting the control values of the projection angles to temporary correction values with an error model using an assumed parameter,
reconstructing a plurality of temporarily corrected images using the temporary correction values of the projection angles for each of different projection data sets composed of a part of the series of projection data,
evaluating consistency of the plurality of temporarily corrected images, and
determining an optimum parameter used for the error model based on the evaluated consistency.
